(19) United States
(12) Patent Application Publication
(10) Pub. No.: US 2012/0275204 A1
(43) Pub. Date: Nov. 1, 2012

(54) Bridgeless Power Factor Correcting Circuits with two Switches

(76) Inventor: Vatche Vorperian, Irvine, CA (US)

(21) Appl. No.: 13/093,854

(22) Filed: Apr. 26, 2011

(51) Int. Cl. H02M 7/155; H02M 7/06

(52) U.S. Cl. 363/126

(57) ABSTRACT

Six, non-isolated, high-frequency, PWM dc-to-dc converters with two switches and bipolar output voltage are reported to perform power factor correction without requiring a bridge rectifier circuit on their input AC side. The first three of these converters have a voltage conversion ratio which is a singular function of the duty cycle and are used to obtain DC output voltages that are larger than the peak AC input voltage. The other three converters are the bilateral inverses of the first three which have a current conversion ratio which is a singular function of the duty cycle and are used to obtain DC output voltages that are significantly lower than the peak AC input voltage. No PFC circuits using only two switches have been known to the prior art.

### BACKGROUND

1. Field of invention

This invention is related to the field of high-frequency, pulse-width-modulated (PWM), ac-to-dc unity power factor correcting (PFC) circuits whose input impedance appears purely resistive to the AC source which allows the input line current to follow the input AC line voltage eliminating reactive power.

2. Prior Art

In the art prior to U.S. Pat. No. 4,412,227A (Mitchell), all PFC circuits comprised a high-frequency, PWM, dc-to-dc converter, a full-bridge rectifier for converting the input ac voltage waveform to a full-wave rectified voltage waveform, and a feedback control circuit which for sensing the input current and forcing it to follow the input voltage. The universally used dc-to-dc converter mentioned above is the boost converter operating in continuous conduction mode for which the feedback control loop can be implemented in a variety ways. For low power applications, the flyback or buck-boost PWM dc-to-dc converter, operating in discontinuous conduction mode, is also used widely. This converter is called an automatic power factor correcting circuit because its input impedance is real without the need of a current feedback control loop. Regardless of the control loop implementation, or the type of the converter used, all the PFCs described above require six switching devices: four diodes in the bridge rectifier, a MOSFET and a diode in the dc-to-dc converter.

In U.S. Pat. No. 4,412,227A (Mitchell), the input bridge rectifier circuit was eliminated by having two boost converters each operate on one half of the input ac cycle. Hence, this invention claimed to reduce the number of switches required to perform power factor correction from six to four. Variations and improvements of this patent since its introduction have been introduced but they all require four or five switches and one or two boost converters. These variations have been covered by the following US patents:

U.S. Pat. No. 6,411,535 B1 (Roux)

U.S. Pat. No. 6,570,366 B1 (Lin et al.)

U.S. Pat. No. 6,671,192 B2 (Maeda et al.)

U.S. Pat. No. 7,215,560 B2 (Soldano et al.)

In US patent 2010/0259240 (Cuk) a new resonant-PWM hybrid dc-to-dc converter has been introduced which accepts a bipolar input voltage and produces a unipolar output voltage. In this patent it is explained that the unique ability of this new dc-to-dc converter to accept bipolar input enables it to be used as an ac-to-dc PFC converter requiring neither an input rectifier bridge nor two dc-to-dc converters each operating on one half of the input ac cycle voltage. In paragraph [0038] of this patent the inventor clearly explains that until his invention of the new hybrid PWM-resonant converter, there were no PWM dc-to-dc converters which could accept bipolar input voltage and produce a unipolar output voltage.

### SUMMARY OF THE INVENTION

All of the PFCs in the entire prior art described above share the misconception that high-frequency, PWM, dc-to-dc converters cannot accept a bipolar input voltage and produce a unipolar output voltage. This invention shows that this is not true and that indeed there are certain known PWM dc-to-dc converters which, by proper control and physical realization of the switches using MOSFETS, diodes or IGBTs, can be made to accept a bipolar input voltage and produce a unipolar dc output voltage. All these PWM dc-to-dc converters share the common feature of being able to produce a bipolar output voltage from a unipolar dc input voltage. The synthesis of these converters using two, four or a larger even number of switches has been discussed in the works of Tymerski and Maksimovich in [2,3]. Since the primary goal of this invention is the discovery of PFCs with the least number of switches, only those dc-to-dc converters with two switches and bipolar output reported in [2,3] are considered while the rest are discarded.

Thus the PFC circuits introduced in this patent, which are based on the dc-to-dc converters described above, are true bridgeless PFC circuits which require only two switches which is the smallest possible number of switches that a PFC can have. All PFCs in the prior art have three or more switches.

### DESCRIPTION OF THE DRAWINGS

FIG. 1a: The Watkins-Johnson PFC in which the switches are realized by the parallel combination of an IGBT and a diode. This PFC produces a dc output voltage which is greater than or equal to the amplitude of the ac input voltage.

FIG. 1b: The rotated SEPIC PFC in which the switches are realized by the parallel combination of an IGBT and a diode. This PFC produces a dc output voltage which is greater than or equal to the amplitude of the ac input voltage.

FIG. 1c: The rotated inverse SEPIC PFC in which the switches are realized by the parallel combination of an IGBT and a diode. This PFC produces a dc output voltage which is greater than or equal to the amplitude of the ac input voltage.

FIG. 1d: The inverse Watkins-Johnson PFC in which the switches are realized by the series combination of a MOSFET and a diode. This PFC produces a dc output voltage which is smaller than the amplitude of the ac input voltage.

FIG. 1e: The inverse rotated SEPIC PFC in which the switches are realized by the series combination of a MOSFET and a diode. This PFC produces a dc output voltage which is smaller than the amplitude of the ac input voltage.

FIG. 1f: The inverse rotated inverse SEPIC PFC in which the switches are realized by the series combination of a MOSFET and a diode. This PFC produces a dc output voltage which is smaller than the amplitude of the ac input voltage.

FIGS. 2a: The Watkins-Johnson dc-to-dc converter using ideal switches. The voltage conversion ratio of this converter is singular at D=0.5.

FIGS. 2b: The rotated SEPIC dc-to-dc converter using ideal switches. The voltage conversion ratio of this converter is singular at D=0.5.

FIGS. 2c: The rotated inverse SEPIC dc-to-dc converter using ideal switches. The voltage conversion ratio of this converter is singular at D=0.5.

FIGS. 2d: The inverse Watkins-Johnson dc-to-dc converter using ideal switches. The current conversion ratio of this converter is singular at D=0.5 and its voltage conversion ratio is zero.

FIGS. 2e: The inverse rotated SEPIC dc-to-dc converter using ideal switches. The current conversion ratio of this converter is singular at D=0.5 and its voltage conversion ratio is zero.

FIGS. 2f: The inverse rotated inverse SEPIC dc-to-dc converter using ideal switches. The current conversion ratio of this converter is singular at D=0.5 and its voltage conversion ratio is zero.

FIG. 3: The voltage conversion ratio as a function of the duty ratio of the dc-to-dc converters in FIGS. 2a,b and c.

FIG. 4a: Non-inverting Watkins-Johnson converter which operates with a duty cycle less than 0.5 and whose conversion ratio is given by Eq. (3).

FIG. 4b: Inverting Watkins-Johnson converter which operates with a duty cycle less than 0.5 and whose conversion ratio is given by Eq. (4).

FIG. 5: The ideal rectification ratio for the PFCs in FIGS. 1a, b and c.

FIG. 6: The real rectification ratio of the PFCs in FIGS. 1a, b and c in the presence of any internal parasitic resistance.

FIG. 7: A circuit that transfers the duty cycle from M1 to M2 for the PFCs in FIGS. 1a, b and c:

FIG. 8 practical rectification ratio of the PFCs in FIGS. 1a, b and c in which the duty cycle is transferred from M1 to M2 as the input voltage reverses.

FIG. 9: Simulated input voltage and current waveforms of the Watkins Johnson-converter obtained from the simulation circuit in FIG. 10. The output voltage is 400Vdc, the output power is W and the input voltage is 300Vac.

FIG. 10: The simulation circuit in LT spice for the Watkins-Johnson PFC with an input filter.

FIG. 11: The voltage conversion ratio characteristics of the dc-to-dc converters used in the PFCs in FIGS. 1d, e and f.

FIG. 12: The rectification ratio of the PFCs in FIGS. 1d, e and f. The duty cycle is transferred from S1 (M1, D1) to S2 (M2, D2) as the input voltage polarity reverses.

FIG. 13: The simulation circuit in LT spice of the inverse rotated SEPIC PFC in FIG. 1e. The PWM section in this simulation diagram shows the mechanism of transferring the duty-cycle from S1 to S2.

FIG. 14: the simulated input voltage and current waveforms obtained from the simulation circuit in FIG. 13 with only the current loop closed.

### DETAILS OF THE INVENTION

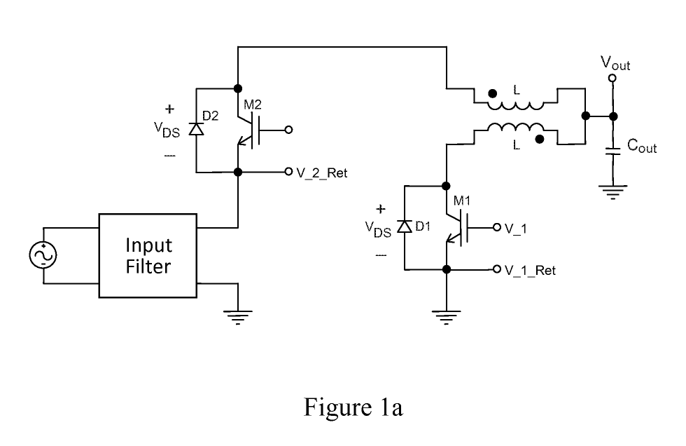

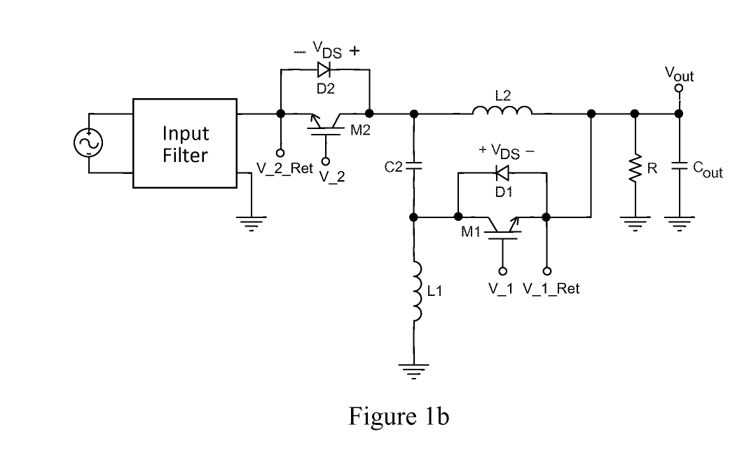

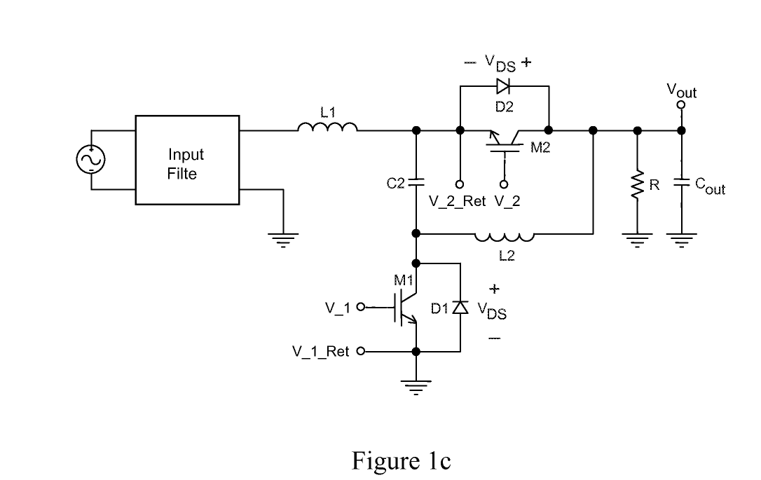

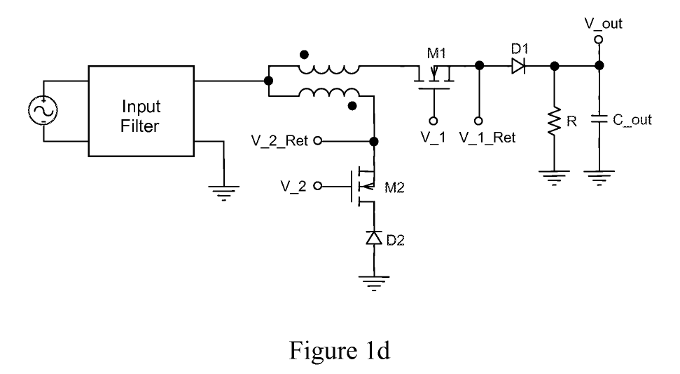

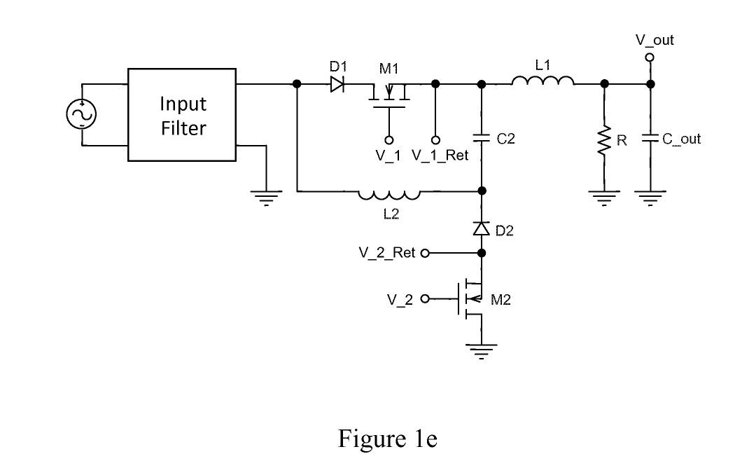

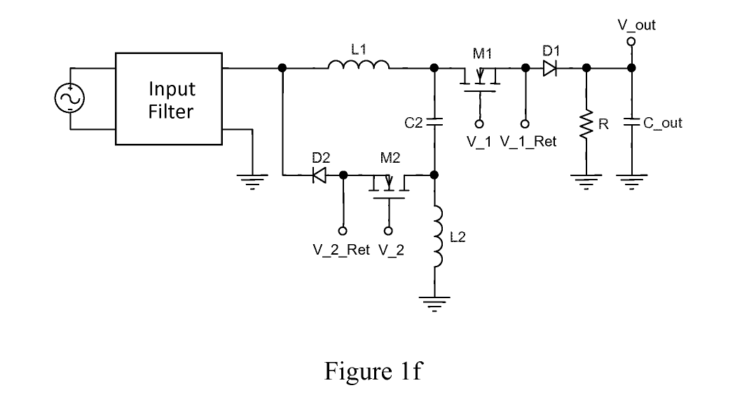

The first three PFCs in this invention are shown in FIGS. 1a, b and c. The PFC in FIG. 1a is based on the dc-to-dc converter known as the Watkins-Johnson converter [1]. The other two PFCs in FIGS. 1b and 1c are based on variants of the SEPIC dc-to-dc converter.

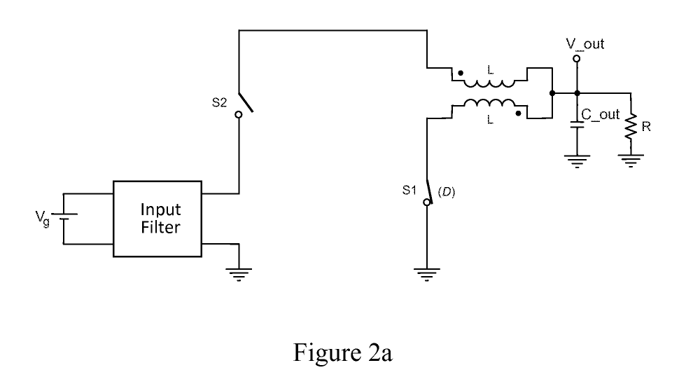

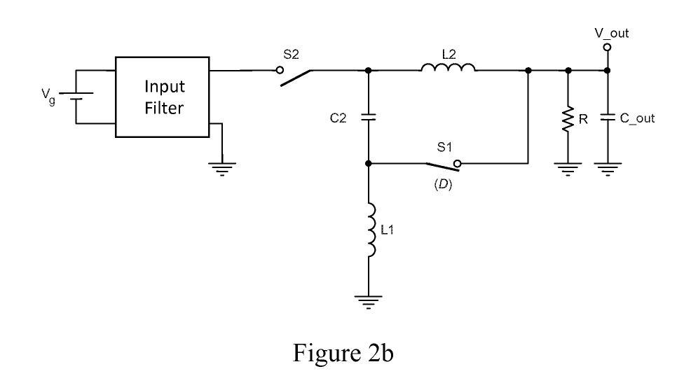

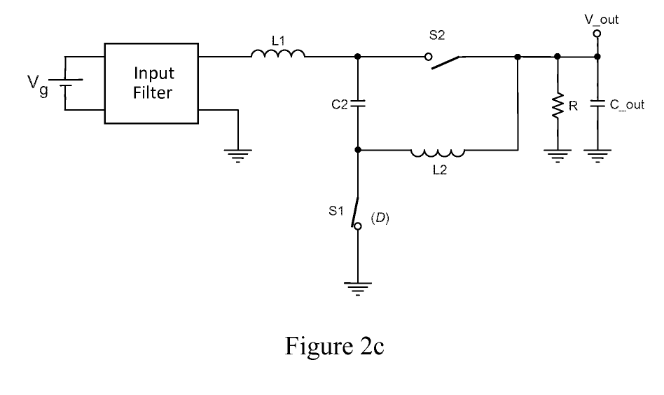

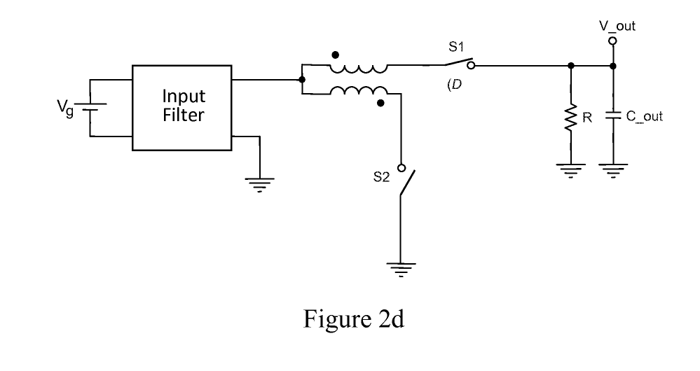

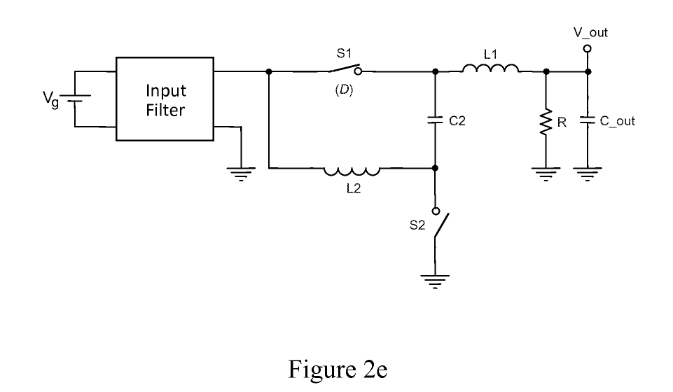

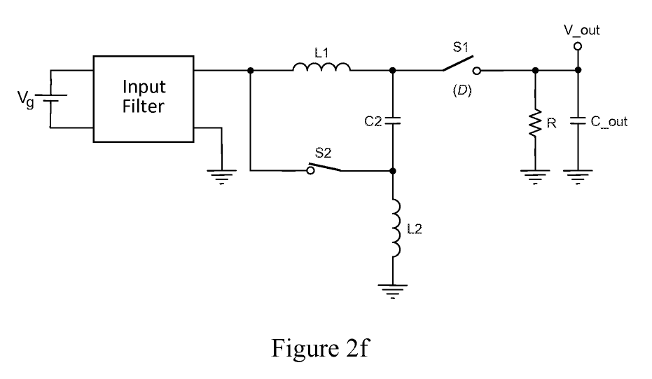

The dc-to-dc converters, on which these PFCs are based, are shown in FIGS. 2a, b and c in which S1 and S2 are ideal two quadrant switches which block voltage in both directions and conduct current in one direction. In contrast, the switches in the PFCs corresponding to these converters are two quadrant switches which block voltage in one direction and conduct current in both directions. The output voltage of these dc-to-dc converters is given by:

$${V}_{o} = {V}_{g} \frac{1 - D}{1 - 2 D} \qquad ( 1 )$$

In Eq. (1) V_{g} is the dc input voltage and D is the duty cycle taken with respect to S1. The voltage conversion ratio of a dc-to-dc converter is defined as the ratio of the dc output voltage to the dc input voltage, so that we have:

$$\begin{matrix}{M}_{V} ≡ \frac{{V}_{o}}{{V}_{g}} = \frac{1 - D}{1 - 2 D} ; & 0 < D < 1\end{matrix} \qquad ( 2 )$$

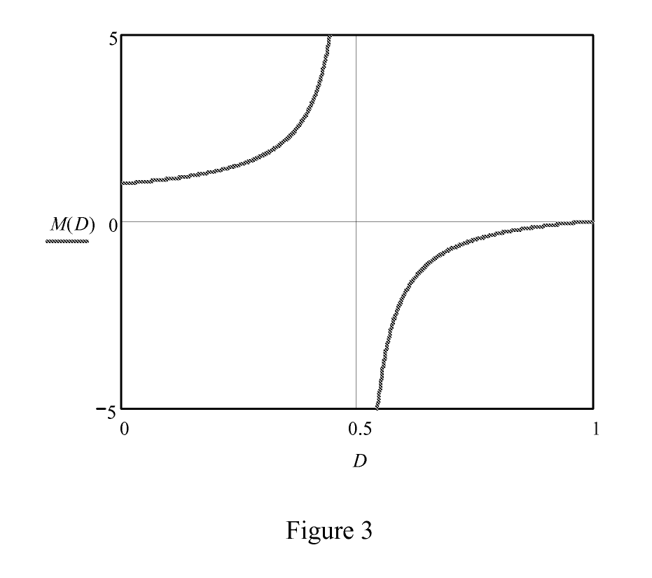

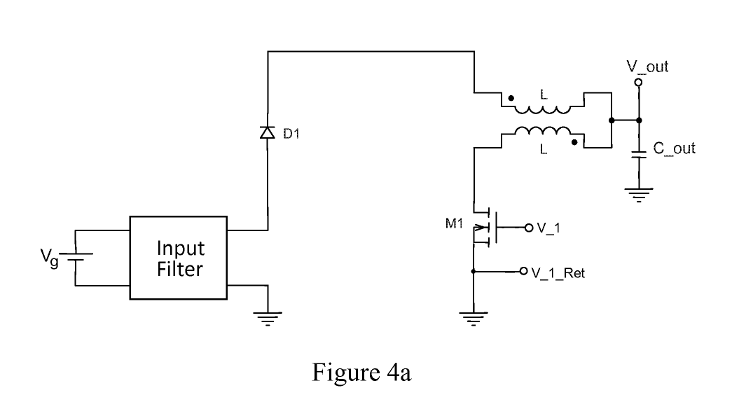

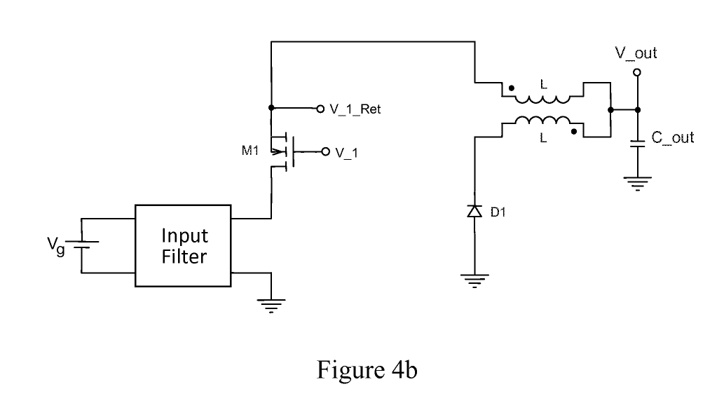

Equation (2) is plotted in FIG. 3 whence we see that for a positive input voltage, V_{g}, the output voltage changes sign as the duty cycle is increased past 0.5. In reality, these converters are never used in bipolar output mode unless they are intended to be used as dc-to-ac inverters (with considerable zero-crossing distortion.) Instead they are either used in the inverting or non-inverting mode as shown in the example of the Watkins Johnson converter in FIGS. 4a and 4b. For the non-inverting configuration with positive output voltage shown in FIGS. 4a, the conversion ratio is given:

$$\begin{matrix}{M}_{V} = \frac{1 - D}{1 - 2 D} ; & 0 < D < 0.5\end{matrix} \qquad ( 3 )$$

When the active and passive switches in FIG. 4a are interchanged, we obtain the inverting configuration shown in FIGS. 4b, whose conversion ratio is given by:

$${M}_{V} = \frac{D}{2 D - 1} ; 0 < D < 0.5 \qquad ( 4 )$$

In a PFC, the goal is to accept a bipolar input and produce a unipolar dc output voltage. Hence, according to the conversion ratio characteristics in FIG. 3, we see that it should be possible to operate these converters as a PFC circuit if we operate any one of these dc-to-dc converters with D<0.5 when the input voltage is positive, and with D>0.5 when the input voltage is negative. In fact we can define the rectification ratio of such a PFC circuit as the ratio of the dc output voltage to the amplitude, Vₚ, of the ac input voltage, vᵢₙ(t)=Vₚ sin ωₗt:

$${M}_{R} ≡ \frac{{V}_{o}}{{V}_{p}} = ‖ \frac{1 - D}{1 - 2 D} ‖ \qquad ( 5 )$$

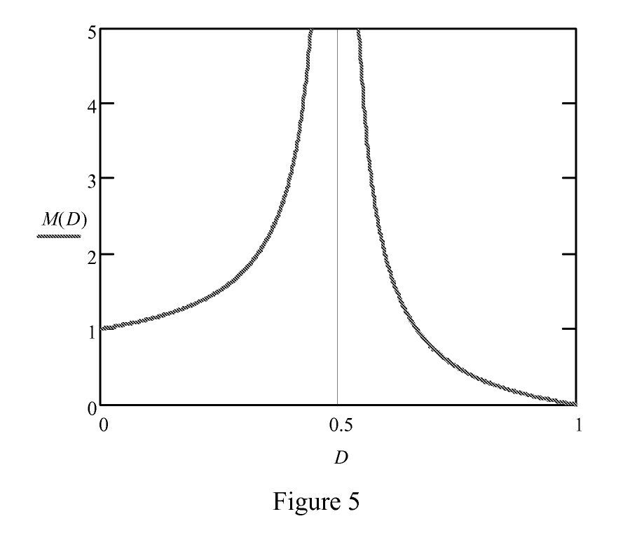

A plot of M_{R} is shown in FIG. 5. In reality, any physical converter will have some parasitic resistance in its internal wiring which, no matter how small, will make the conversion ratio become zero at D=0.5 instead of becoming singular. The nonideal conversion ratio for any of these three converters in the presence of an effective internal resistance, r, is given by:

$${M}_{V} = {M}_{o} \frac{1}{1 + \frac{r}{{R}_{L}} {M}_{o}^{2}} \qquad ( 6 )$$

In which Mₒ is the ideal conversion ratio in Eq. (2):

$${M}_{o} = \frac{1 - D}{1 - 2 D} \qquad ( 7 )$$

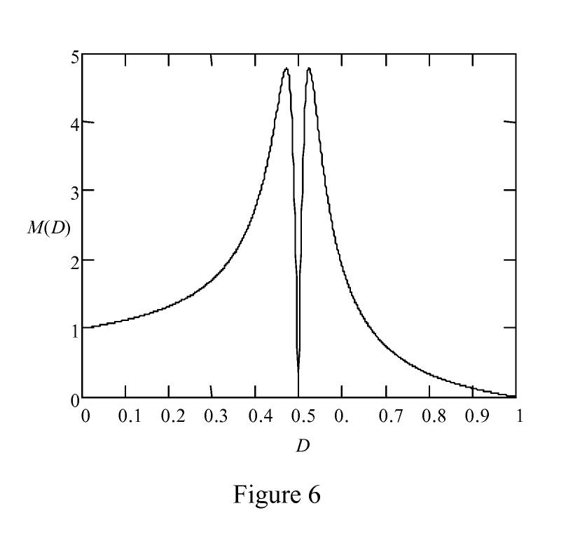

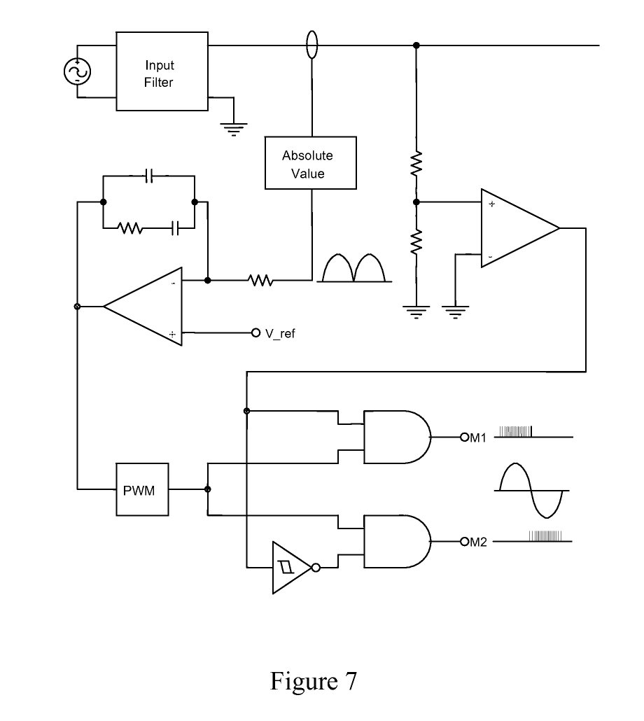

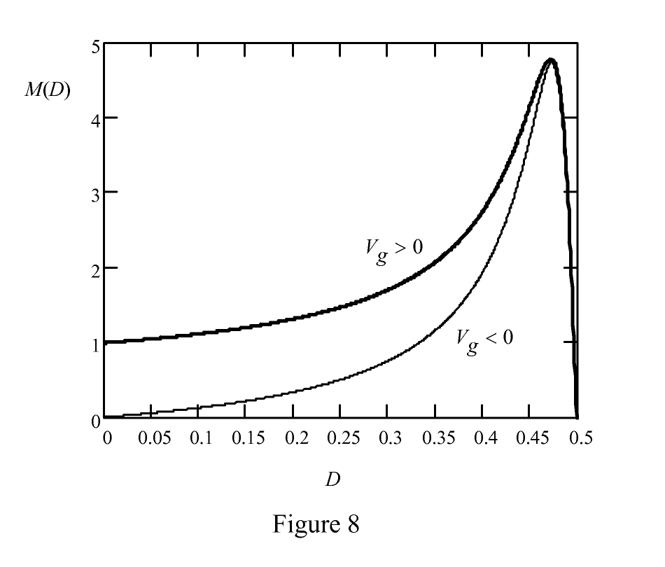

A plot of a typical practical rectification ratio M_{R}=|M_{V}| based on Eq. (6) is shown in FIG. 6 which is not monotonic over the interval Dε[0,1] and hence cannot be part of a stable, closed loop regulating system. To overcome this instability problem, we restrict the duty cycle to Dε[0,1/2] by transferring it from the S1 to S2 as the input voltage reverses which effectively allows for S1 to continue operating with a duty cycle greater than 0.5 over the negative input cycle. A simple circuit that transfers the duty cycle from S1 to S2 is shown in FIG. 7. The transfer of the duty cycle as described effectively folds over the rectification ratio in FIG. 6 about D=0.5 axis as shown in FIG. 8 in which we see M_{R} is monotonic for negative and positive values of the input voltage provided we operate below the peak. FIG. 8 is the basis of the novel PFCs introduced in this patent.

The switch realization of the PFCs shown in FIGS. 1a,b and c consists of an IGBT in parallel with a diode. A MOSFET would have been the ideal realization of these switches had it not been for its slow body diode. With advances in SiC and GaN technologies such MOSFETs may become available in the future.

Finally, the drain-to-source voltage, in all three converters is given by:

$$\begin{matrix}{V}_{DS} = 2 {V}_{o} - {V}_{g} \\ = 2 {V}_{o} - {v}_{g} ( t ) \\ = 2 {V}_{o} - {V}_{p} sin {ω}_{l} t\end{matrix} \qquad ( 8 )$$

Therefore, the maximum value of V_{DS} is given by:

V_{DS}_{₁₃}ₘₐₓ=2Vₒ+Vₚ (9)

Since, the minimum possible value of the output voltage in all three converters is equal to the peak line voltage, we have:

V_{DS}_{_{—}}ₘₐₓ=3Vₒ (10)

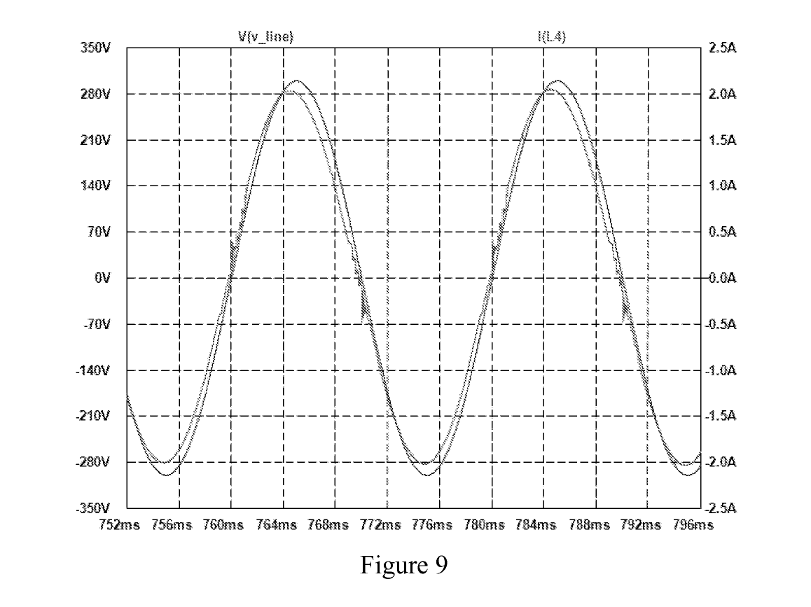

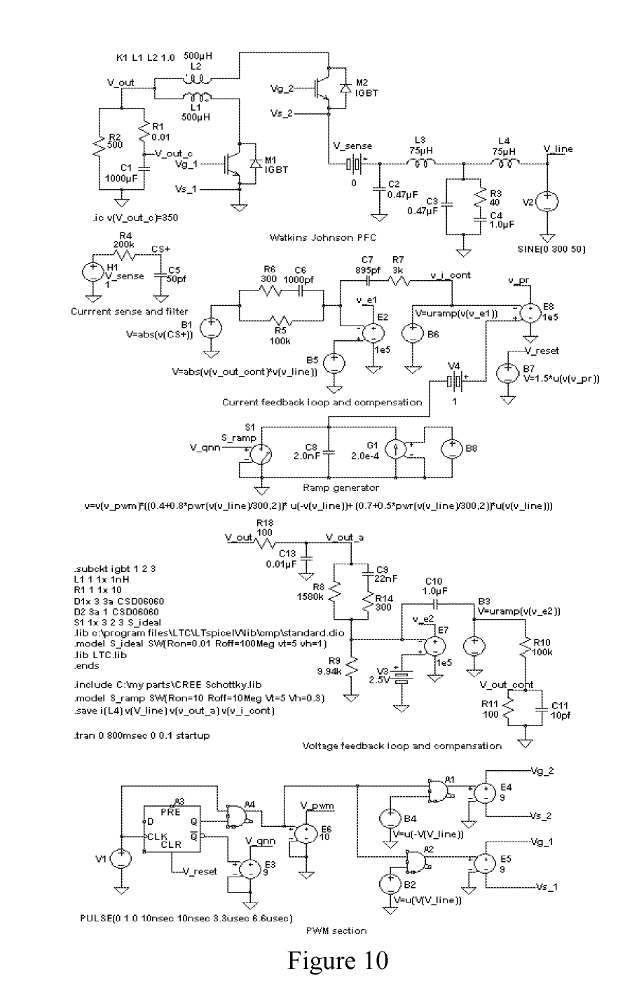

Simulation results are shown in FIG. 9 using a the Watkins-Johnson PFC. The simulation circuit is shown in FIG. 10 in which a feed-forward compensation scheme given by:

Sᵣ(t)=(k₁+k₂ sin²(ωₗt))u(vᵢₙ)+u(−vᵢₙ)(k₃+k₄ sin²(ωₗt)) (11)

is used to improve the distortion in the current waveform at zero-crossing.

The remaining three PFC circuits shown in FIGS. 1d, e and f are based on dc-to-dc converters which have an ideal voltage conversion ratio given by:

$${M}_{V} = \frac{2 D - 1}{D} \qquad ( 12 )$$

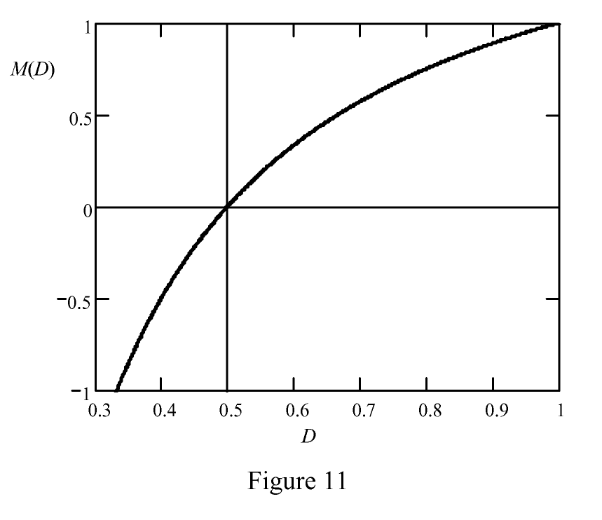

Equation (12) is plotted in FIG. 11 in which we see that the voltage conversion ratio passes through zero at D=0.5. The range of Mᵥ in FIG. 11 is shown limited to [−1,1] because the positive conversion ratio cannot exceed unity making these PFCs suitable only for obtaining output voltages which are less than the peak input voltage.

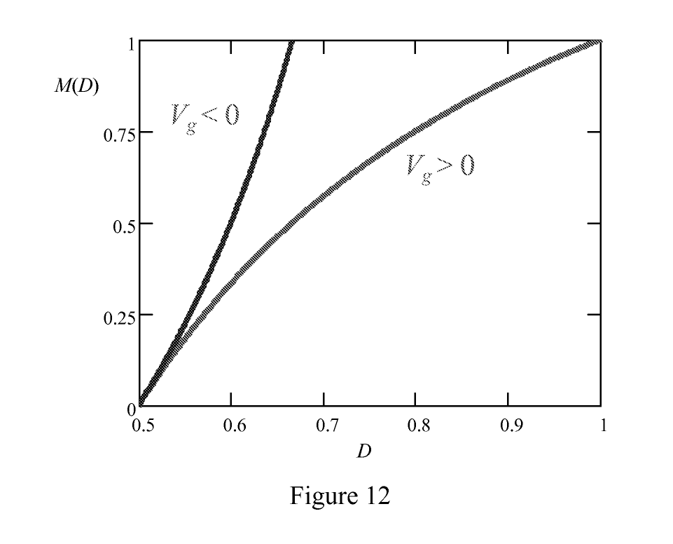

Following the same argument given earlier for the first three PFCs, we arrive at the conclusion that these PFCs can be operated controllably and produce a dc output voltage which is less than the peak input voltage if the duty cycle is restricted to greater than 50% and transferred from S1, (M1, D1), to S2, (M2, D2), as the input voltage reverses from positive to negative in accordance with the rectification ratio shown in FIG. 12 which is a folded version of the absolute value of the conversion ratio in FIG. 11.

The switches, S1 and S2, in these PFCs are two quadrant switches which conduct current in one direction but block voltage in both directions whose maximum value is:

V_{DS}_{_{—}}ₘₐₓ=2Vₚ+Vₒ (13)

The switches in these converters can be physically realized by an ideal IGBT but, since a practical IGBT cannot block voltages effectively in the reverse direction, a diode must be added in series with the drain as shown.

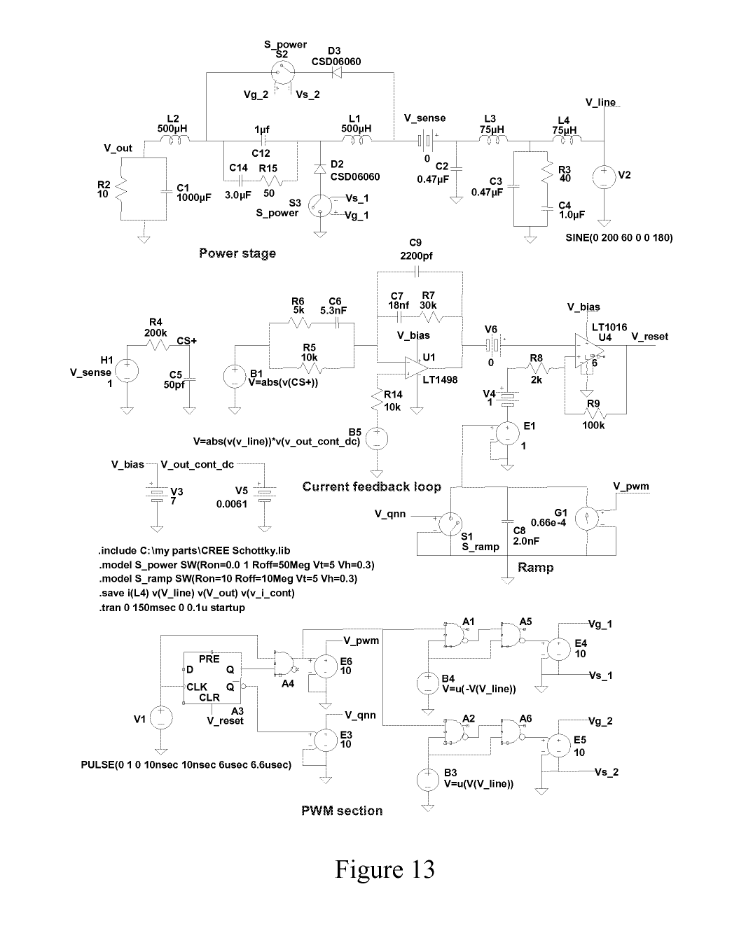

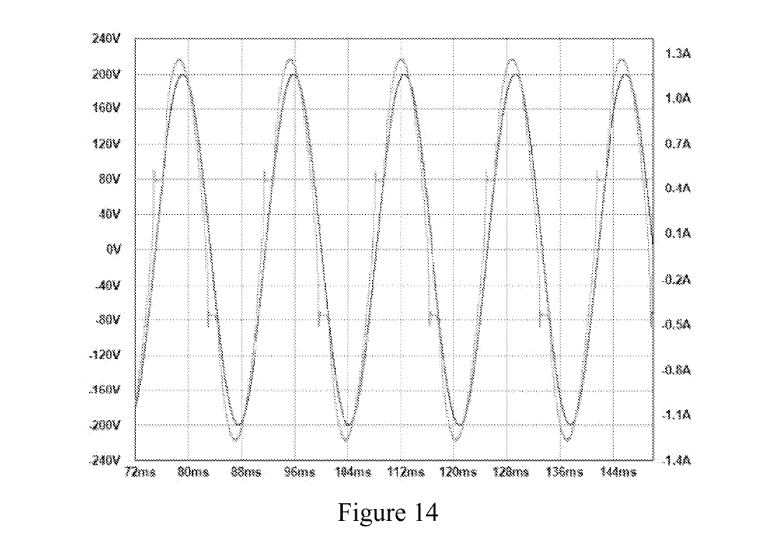

Finally, for these PFCs, when the duty cycle is transferred from one MOSFET to the other as the input voltage reverses, the other MOSFET is turned on for the entire duration of the half cycle of the input voltage. A logic circuit that accomplishes this is shown in the PWM section of the real time simulation circuit shown in FIG. 13. The simulated input voltage and current waveforms, with only the current loop closed, obtained from FIG. 13 are shown in FIG. 14 in which we see that the current waveform has some distortion at zero crossing.

### REFERENCES

[1] B. Israelson, J. Martin, C. Reeve and V. Scown, “A 2.5 kV high reliability TWT power supply: design techniques for high efficiency and low ripple,” Proceeding of he 1977 IEEE Power Electronics Specialist Conference, PESC 77 Record, pp. 109-130.
[2] R. P. E. Tymerski, “Topology and analysis in power conversion and inversion,” Ph.D. Dissertation, Dept. of Electrical Engineering, Virginia Polytechnic Institute and State University, Apr. 22, 1988.
[3] D. Maksimovich and S. Cuk, “General unified properties and synthesis of PWM converters,” Proceedings of the 1989 IEEE Power Electronics Specialists Conference, PESC 89 Record.

1. All PWM dc-to-dc converters which have a bipolar voltage conversion ratio can be configured as a bridgeless, single-phase, power factor correcting ac-to-dc converter by appropriate physical realization of the switches and transfer of the duty cycle from one switch to the other as the input voltage reverses polarity.

2. There are three PWM dc-to-dc converters as described in claim land shown in FIGS. 2a, b and c, which have two switches and an ideal voltage conversion ratio which is a bipolar and singular function of the duty cycle, D, given by:
$$\begin{matrix}{M}_{V} ≡ \frac{{V}_{o}}{{V}_{g}} = \frac{1 - D}{1 - 2 D} ; & 0 < D < 1\end{matrix} \qquad ( 1 )$$
These dc-to-dc converters can be configured as bridgeless, single-phase, power factor correcting ac-to-dc converters (PFC) as shown in Figures la, b and c whose output dc voltage is larger than the amplitude, Vₚ, of the ac input voltage, vᵢₙ(t)=Vₚsin ωₗt.

3. The switches in the three PFCs described in claim 2 are realized in a way to conduct current in both directions and block voltage in a single direction. One such realization is the anti-parallel combination of an IGBT with a diode. Another realization is a pair of synchronously driven MOSFET switches.

4. For stable operation of the three PFCs described in claims 2, the duty cycle, D, is restricted to less 0.5 and transferred from the first switch to the second switch as the input ac voltage reverses. The resulting rectification ratio of the PFCs in claim 2 is given by:
$${M}_{R} ≡ \frac{{V}_{o}}{{V}_{p}} = \{ \begin{matrix}\begin{matrix}\frac{1 - D}{1 - 2 D} ; {V}_{g} > 0 \\ \frac{D}{2 D - 1} ; {V}_{g} < 0\end{matrix} ; & 0 < D < \frac{1}{2}\end{matrix} \qquad ( 2 )$$

5. There are three other PWM dc-to-dc converters as described in claim 1, shown in FIGS. 2d, e and f, which have only two switches and an ideal voltage conversion ratio which is a bipolar function of the duty cycle, D, given by:
$$\begin{matrix}{M}_{V} ≡ \frac{{V}_{o}}{{V}_{g}} = \frac{2 D - 1}{D} ; & 0 < D < 1\end{matrix} \qquad ( 3 )$$
These dc-to-dc converters can be configured as bridgeless, single-phase, power factor correcting ac-to-dc converters (PFC) as shown in FIGS. 2d, e and f whose output dc voltage is less than the amplitude, Vₚ, of the ac input voltage, vᵢₙ=Vₚsin ωₗt.

6. The switches in the three PFCs described in claim 5 are realized in a way to conduct current in one directions and block voltage in both directions. One such realization is the series combination of a MOSFET and a diode. Another realization is an IGBT in series with a diode.

7. For stable operation of the three PFCs described in claims 5, the duty cycle, D, is restricted to greater 0.5 and transferred from the first switch to the second switch as the input ac voltage reverses. The resulting rectification ratio of the PFCs in claim 5 is given by:
$${M}_{R} ≡ \frac{{V}_{o}}{{V}_{p}} = \{ \begin{matrix}\begin{matrix}\frac{2 D - 1}{D} ; {V}_{g} > 0 \\ \frac{2 D - 1}{1 - D} ; {V}_{g} < 0\end{matrix} ; & \frac{1}{2} < D < 1\end{matrix} \qquad ( 4 )$$
